(19) United States
(12) Patent Application Publication
(10) Pub. No.: US 2012/0076086 A1
(43) Pub. Date: Mar. 29, 2012

(54) ASYMMETRICAL LINKS IN WIRELESS COMMUNICATIONS

(75) Inventors: Dudu Bercovich, Kfar-Saba (IL); Yitzhak Aviv, Petach-Tikva (IL)

(73) Assignee: Ceragon Networks Ltd., Tel-Aviv (IL)

(21) Appl. No.: 13/245,911

(22) Filed: Sep. 27, 2011

Related U.S. Application Data
(60) Provisional application No. 61/386,638, filed on Sep. 27, 2010.

(51) Int. Cl. H04W 72/04; H04W 84/00

(52) U.S. Cl. 370/329

(57) ABSTRACT

A method of allocating wireless communication capacity in a wireless point-to-point link including obtaining a channel having a bandwidth for use in the wireless point-to-point link, allocating a first portion of the bandwidth for use for transmitting from a first point to a second point of the wireless point-to-point link, and allocating a second portion of the bandwidth for use for transmitting from the second point to the first point of the wireless point-to-point link, in which the bandwidth is asymmetrically assigned between the first portion and the second portion. Related apparatus and methods are also described.

### RELATED APPLICATIONS

This application claims the benefit of priority under 35 USC 119 (e) of U.S. Provisional Patent Application No. 61/386,638 filed Sep. 27, 2010, the contents of which are incorporated herein by reference in their entirety.

### FIELD AND BACKGROUND OF THE INVENTION

The present invention, in some embodiments thereof, relates to a wireless communications system and, more particularly, but not exclusively, to a point-to-point wireless communications system.

A standard allocation for point-to-point wireless radio systems is a pair of frequency bands, including a low frequency band and a high frequency band with a gap between them.

A wireless link supplier typically buys the pair of frequency bands, one for transmitting from a first point to the second point, and one for transmitting from the second point to the first point.

Traditionally, the two frequency bands have equal bandwidth. Traditionally equal wireless capacity is provided in both directions, and a frequency gap is typically ensured between the two frequencies.

Reference is now made to FIG. 1, which is a simplified block diagram illustration of a prior art bandwidth allocation for a point-to-point wireless communication link.

FIG. 1 depicts a traditional use of a first frequency F1 101 for a first direction of the point-to-point link, and a second frequency F1′ 102 for a second, opposite, direction of the point-to-point link. A frequency gap 103 is depicted between the first frequency F1 101 and the second frequency F1′ 102.

### SUMMARY OF THE INVENTION

As described above, with reference to FIG. 1, traditionally wireless point-to-point links are set up to have a symmetrical capacity in both directions, having equal bandwidth in both directions.

As used in practice, the point-to-point links often require asymmetrical capacity. The term uplink is used herein for a link which requires less capacity, and the term downlink is used herein for a link which requires more capacity.

A non-limiting example of asymmetrical capacity in a point-to-point link includes a link between end nodes in a communication network and nodes on trunk lines. Typically, not always, the trunk lines provide more traffic toward the end node, in a downlink direction, than the end nodes toward the trunk line.

Because of different antennas, and/or because of having a power amplifier at a communication node and not at a handset, a downlink requires typically about 3 times more capacity than an uplink requires.

The present invention, in some embodiments thereof, uses available spectrum in a way that takes into consideration the fact that a downlink capacity requirement is typically more than uplink capacity requirement.

The above-mentioned embodiments take an available spectrum, split it into smaller segments, or sub-bands, and allocate the different sub-bands asymmetrically over the links.

Various wireless network configurations are described, the above-mentioned asymmetric allocation proposal is described with reference to the network configurations, and improvements in total traffic carried over the network are shown.

A wireless link supplier typically buys frequency bands from a regulating body, and is allowed to use only those bands which it buys. If the wireless link supplier can improve total traffic carried over the frequency bands it has bought, such an improvement results in lower costs and higher profits for the wireless link supplier.

According to an aspect of some embodiments of the present invention there is provided a method of allocating wireless communication capacity in a wireless point-to-point link including obtaining a channel having a bandwidth for use in the wireless point-to-point link, allocating a first portion of the bandwidth for use for transmitting from a first point to a second point of the wireless point-to-point link, and allocating a second portion of the bandwidth for use for transmitting from the second point to the first point of the wireless point-to-point link, in which the bandwidth is asymmetrically assigned between the first portion and the second portion.

According to some embodiments of the invention, the bandwidth is split into a plurality of substantially equal sub-bands, and in which the sub-bands are allocated to the first portion and to the second portion according to channel usage characteristics.

According to some embodiments of the invention, a number of sub-bands allocated to the first portion is different from a number of sub-bands allocated to the second portion.

According to some embodiments of the invention, the number of sub-bands allocated to the first portion is in a ratio of 3:1 to the number of sub-bands allocated to the second portion.

According to some embodiments of the invention, the wireless link includes a wireless link between an aggregation node and a tail node. According to some embodiments of the invention, the wireless link includes a wireless link between communication nodes in a wireless network having a ring topology.

According to an aspect of some embodiments of the present invention there is provided a method of allocating bandwidth in a wireless communication system between an aggregator node and a plurality of tail nodes, including obtaining a channel having a bandwidth for use between the aggregator node and the plurality of tail nodes, allocating a first portion of the bandwidth for use for transmitting from the aggregator node to the plurality of tail nodes, and allocating a plurality of other portions of the bandwidth for use for transmitting from the tail nodes to the aggregation node, characterized by using the first portion to transmit a same signal to all the tail nodes.

According to some embodiments of the invention, the bandwidth of the first portion is substantially equal to a sum of the bandwidth of the other portions.

According to some embodiments of the invention, the same signal sometimes contains data using up more bandwidth to one of the tail nodes than can be contained in the portion of bandwidth allocated to the same one of the tail nodes for transmitting from the same one of the tail nodes to the aggregation node.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram illustration of a prior art bandwidth allocation for a point-to-point wireless communication link;

FIG. 2 is a simplified block diagram illustration of splitting a frequency band of a point-to-point wireless communication link into sub-bands according to an example embodiment of the present invention;

FIG. 3 is a simplified block diagram illustration of an example embodiment of the present invention;

FIGS. 4A and 4B are simplified block diagram illustrations of another example embodiment of the present invention;

FIGS. 5A and 5B are simplified block diagram illustrations of yet another example embodiment of the present invention;

FIGS. 6A and 6B are simplified block diagram illustrations of still another example embodiment of the present invention;

FIG. 7A is a simplified block diagram illustration of communication nodes in a ring network;

FIG. 7B is a simplified block diagram illustrations of yet another example embodiment of the present invention, applied to a ring network similar in topology to the ring network of FIG. 7A;

FIG. 7C is a simplified block diagram illustration of a network similar to the ring network of FIG. 7B, when a failure occurs in a wireless link far from a root node;

FIG. 7D is a simplified block diagram illustration of a network similar to the ring network of FIG. 7B, when a failure occurs in a wireless link close to a root node;

FIG. 8A is a simplified block diagram of an example embodiment of the invention used for sharing capacity of a wireless point-to-point link; and

FIG. 8B is a simplified block diagram of another example embodiment of the invention used for sharing capacity of a wireless point-to-point link.

### DESCRIPTION OF SPECIFIC EMBODIMENTS OF THE INVENTION

The present invention, in some embodiments thereof, relates to a wireless communications system and, more particularly, but not exclusively, to a point-to-point wireless communications system.

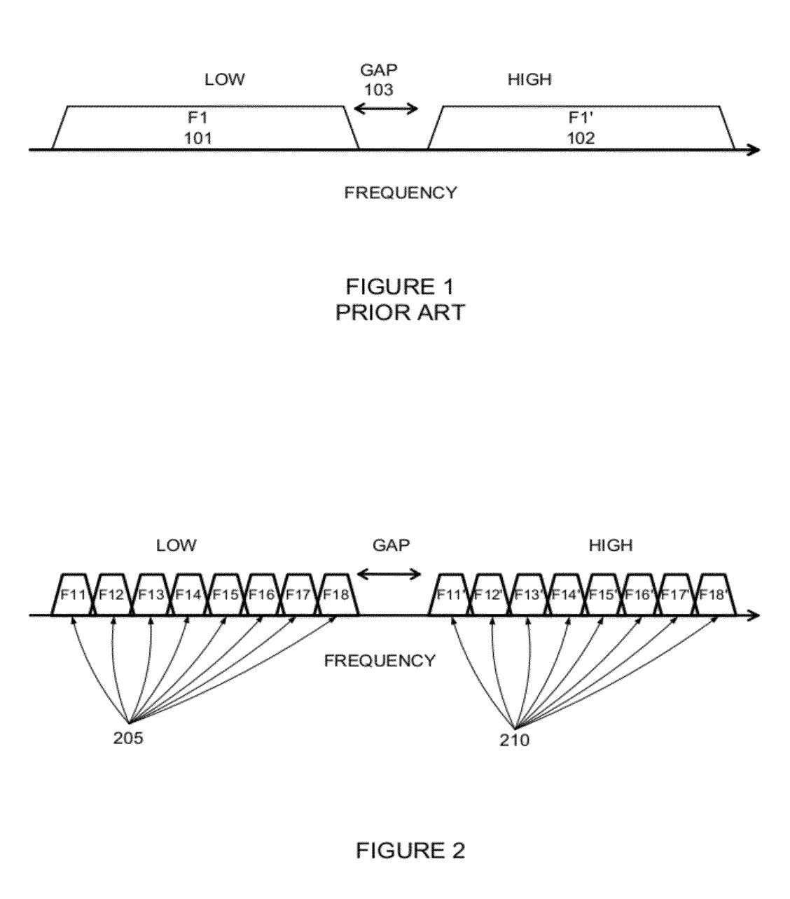

As described above, with reference to FIG. 1, traditionally microwave point-to-point links are symmetrical, having equal bandwidth in both directions.

In practice however, point-to-point traffic capacity requirements are not symmetrical but rather asymmetrical. Because of different traffic patterns, and/or different antennas, and/or because of having a power amplifier at one communication node and not another, one direction, such as a downlink, requires more capacity than another direction, such as an uplink, requires.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

The present invention, in some embodiments thereof, uses available spectrum in a way that takes into consideration the fact that downlink capacity requirement is typically more than uplink capacity requirement.

To provide more capacity in one direction than another, an available spectrum is taken and split it into smaller segments, or sub-bands, for example sub-bands of 7 MHz each, or 3.5 MHz each, and the different sub-bands are allocated asymmetrically over the links.

Reference is now additionally made to FIG. 2, which is a simplified block diagram illustration of splitting a frequency band of a point-to-point wireless communication link into sub-bands 205 210 according to an example embodiment of the present invention.

For example, the first frequency F1 101 (of FIG. 1) of a first direction of the point-to-point link, is split into several sub-bands F11, F12, F13, F14, F15, F16, F17, F18 (205), and the second frequency F1′ 102 (of FIG. 1) of a second, opposite, direction of the point-to-point link, is split into several sub-bands F11′, F12′, F13′, F14′, F15′, F16′, F17′, F18′ (210).

FIG. 2 depicts the sub-bands 205 210 divided equally among the first direction and the second direction. Having achieved a division into sub-bands, the sub-bands, which are all within a band allocated to a wireless link supplier, may be used to carry traffic. However, the traffic capacity requirements may in fact be distributed asymmetrically between the directions, and the wireless carrier may optionally re-use the extra capacity.

The splitting of the allocated frequency bands (F1 and F1′ of FIG. 1) into sub-bands (F11-F18 and F11′-F18′ of FIG. 2) enables the wireless link to use an unequal, asymmetric, number of sub-bands in one direction than are used in the other direction.

It is noted that when two frequency bands are allocated for a wireless link, the two frequency bands, such as F1 and F1′ of FIG. 1, are typically separated by a frequency band gap, such as the gap 103 of FIG. 1. The splitting into sub-bands according to the present invention optionally provides a continuous span of sub-bands, such as F11-F18 of FIG. 2, split from a first frequency band (F1 of FIG. 1) and another continuous span of sub-bands, such as F11′-F18′ of FIG. 2, split from a second frequency band (F1′ of FIG. 1).

Following are several example embodiments of the invention, which take asymmetric traffic capacity requirements into consideration and thus use allocated wireless spectrum more efficiently.

An Example Scenario—Using Asymmetrical Links

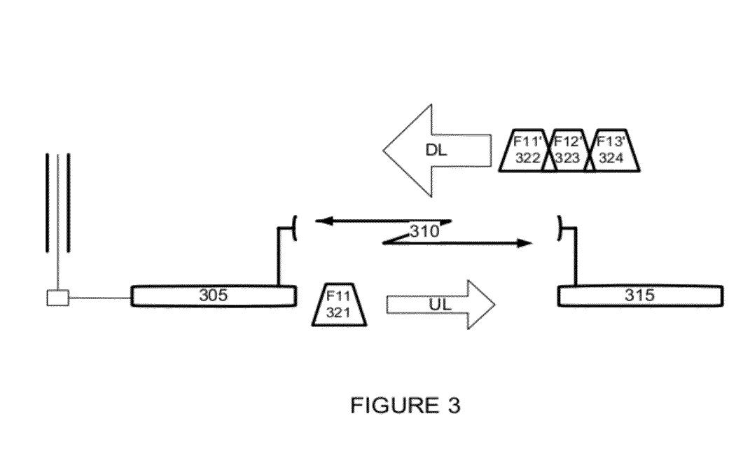

Reference is now made to FIG. 3, which is a simplified block diagram illustration of an example embodiment of the present invention.

FIG. 3 depicts an example scenario in which a first communication node 305 communicates via a wireless point-to-point link 310 to a second communication node 315.

In this example scenario the first communication node 305 is, by way of a non-limiting example, a communication node for communication with mobile handsets, and uplinks traffic to the second communication node 315, which is either connected to a core network, or is a way-station on the way to a core network. In such a scenario, as mentioned above, traffic volume is typically larger in a downlink direction than in an uplink direction, by ay of a non-limiting example by a ratio of 3:1.

The bandwidth allocated to the wireless link is split into, for example, four sub-bands F11 321, F11′ 322, F12′ 323, and F13′ 324.

The first communication node 305 and the second communication node 315 distribute the four sub-bands F11 321, F11′ 322, F12′ 323, and F13′ 324 asymmetrically, with the first communication node 305 using one sub-band F11 321 to uplink, and the second communication node 315 using three sub-bands F11′ 322, F12′ 323, and F13′ 324 to downlink.

The asymmetric distribution of sub-bands, or segments, enables the wireless link between the first communication node 305 and the second communication node 315 to carry about 50% more traffic, using the same spectrum allocation, by having different capacities allocated per direction.

It is emphasized here that an asymmetric capacity requirement across a point-to-point link, with one direction requiring more capacity that the other direction, is often a characteristic of a network, and the example of communication node to core network communications, and is not intended to limit the scope of the invention.

It is emphasized here that a ratio of 3:1 in required capacity between directions in a point-to-point link is not intended to limit the scope of the invention. The ratio of 3:1 enables a wireless link provider to take a frequency band, split the band into, for example, 4 equal-capacity segments, and allocate the four segments to two directions in a ratio of 3:1.

The above example teaches how to handle other ratios: e.g. a 2:1 ration may optionally be handled by, for example, splitting a frequency band into six equal capacity sub-bands, and dividing the six segments into a group of two segments and a group of four segments, achieving a ratio of 4:2=2:1.

An Example Scenario—a Chain of Wireless Links

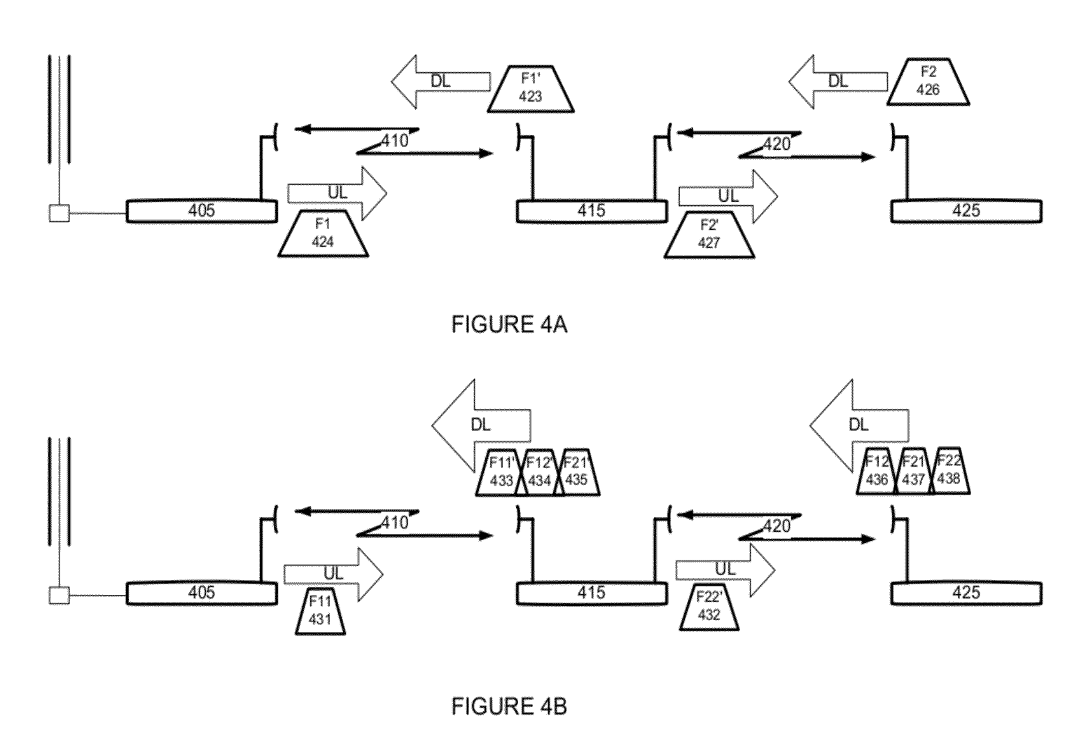

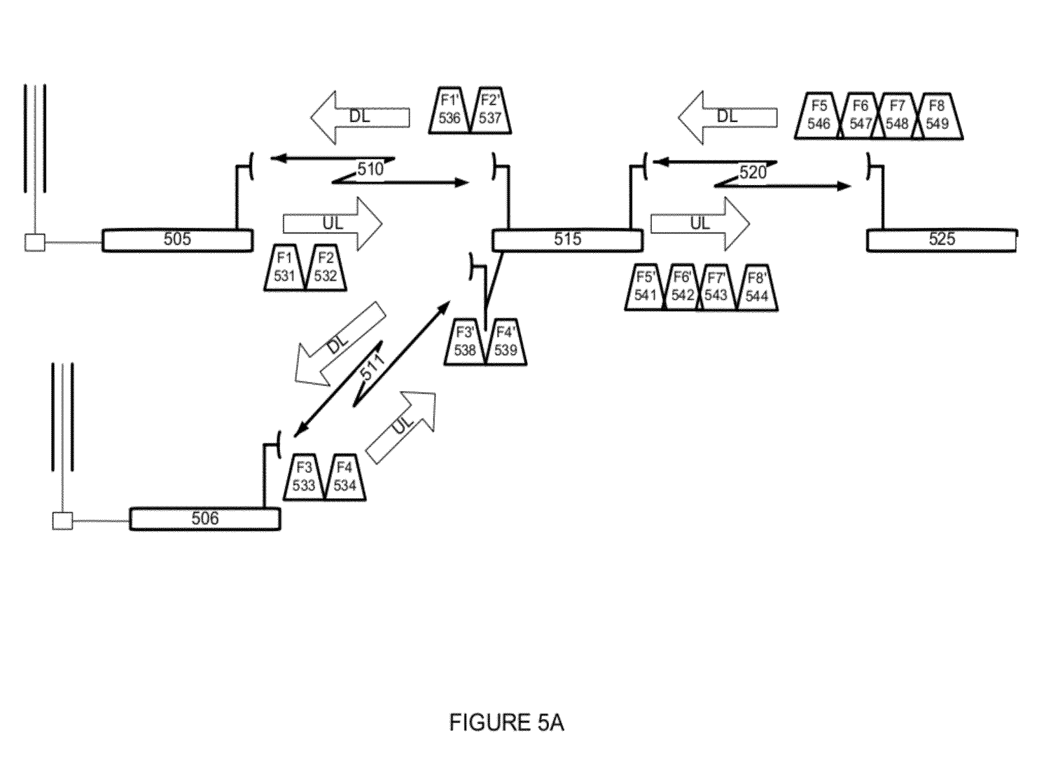

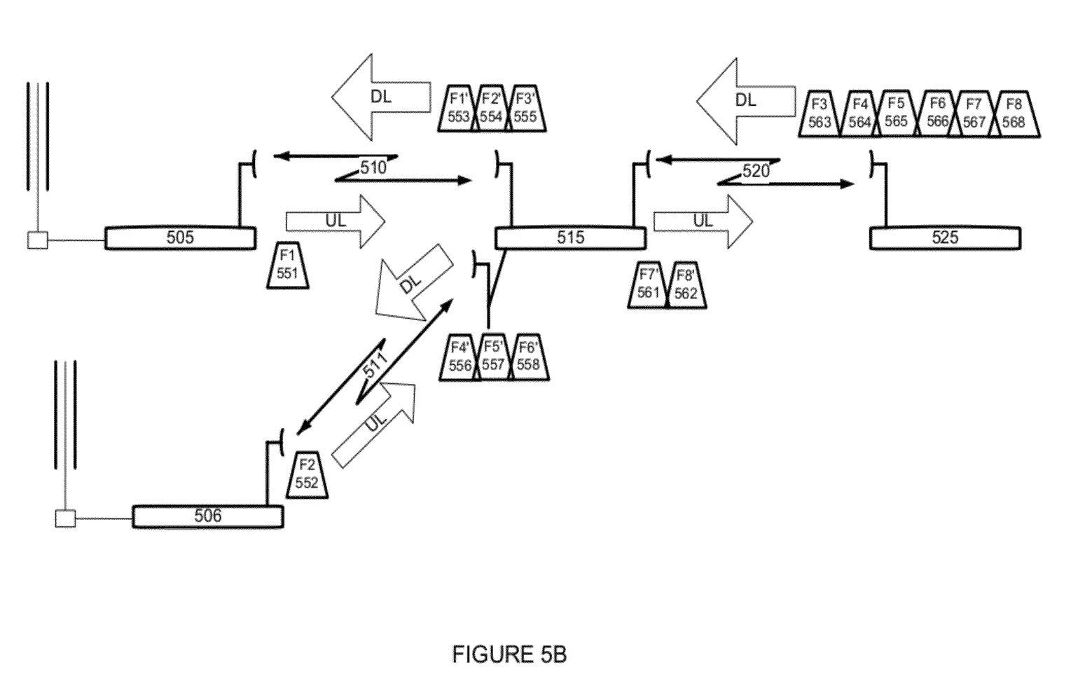

Reference is now made to FIGS. 4A and 4B, which are simplified block diagram illustrations of another example embodiment of the present invention.

FIG. 4A depicts an example scenario in which a first communication node 405 communicates via a first wireless point-to-point link 410 to a second communication node 415, and the second communication node 415 communicates via a second wireless point-to-point link 420 to a third communication node 425.

The scenario of FIG. 4A depicts, for example, a band of 14 MHz, F1′ 423 in a downlink direction in the first link 410, and a band of 14 MHz, F1 424 in an uplink direction in the first link 410. FIG. 4A also depicts, for example, a band of 14 MHz, F2 426 in a downlink direction in the second link 420, and a band of 14 MHz, F2′ 427 in an uplink direction in the second link 420.

FIG. 4A depicts traditional, prior art, use of the band of 14 MHz in each direction, providing a total capacity of about 100 Mbps.

Reference is now made to FIG. 4B, which depicts an example scenario in which the first communication node 405 communicates via the wireless point-to-point link 410 to the second communication node 415, and the second communication node 415 communicates via the wireless point-to-point link 420 to the third communication node 425, using an embodiment of the present invention.

Each of the 14 MHz bands of the example of FIG. 4A F1 424, F1′ 423, F2 426, and F2′ 427, is split into two 7 MHz segments. Overall eight such segments are available: F11 431, F12 436, F11′ 433, F12′ 434, F21 437, F22 438, F21′ 435, F22′ 432.

In the example of FIG. 4B, the segments, or sub-bands, are allocated differently from the example of FIG. 4A. A 7 MHz segment F11 431 is used in the uplink direction of the first link 410, and three 7 MHz segments F11′ 433, F12′ 434, and F21′ 435 are used in the downlink direction.

A 7 MHz segment F22′ 432 is used in the uplink direction of the second link 420, and three 7 MHz segments F12 436, F21 437, and F22 438 are used in the downlink direction. It is noted that the segment F12 438 is split off the band F1 424 (FIG. 4A), and serves for transmitting downlink from the third node 425 to the second node 415, rather than uplink from the first node 405 to the second node 415. It is noted that in some jurisdictions such a transfer of a direction of the segment F12 436 is allowed, and in some jurisdictions is not allowed. The transfer of the direction moves the segment F12 436 from the first wireless link 410 to the second wireless link 420, from one area to a neighboring area.

FIG. 4B depicts a scenario in which the chain of wireless links provides a capacity of about 150 Mbps using a capacity corresponding to a 21 MHz channel in the downlink direction, and a capacity of a 7 MHz channel in the uplink direction, for the same total of 28 Mhz as in FIG. 4A.

Overall the same spectrum, or bandwidth, was allotted to the wireless link provider (28 MHz), and the wireless link provider, in the example of FIG. 4B, provides 50% more capacity.

An Example Scenario—Aggregation

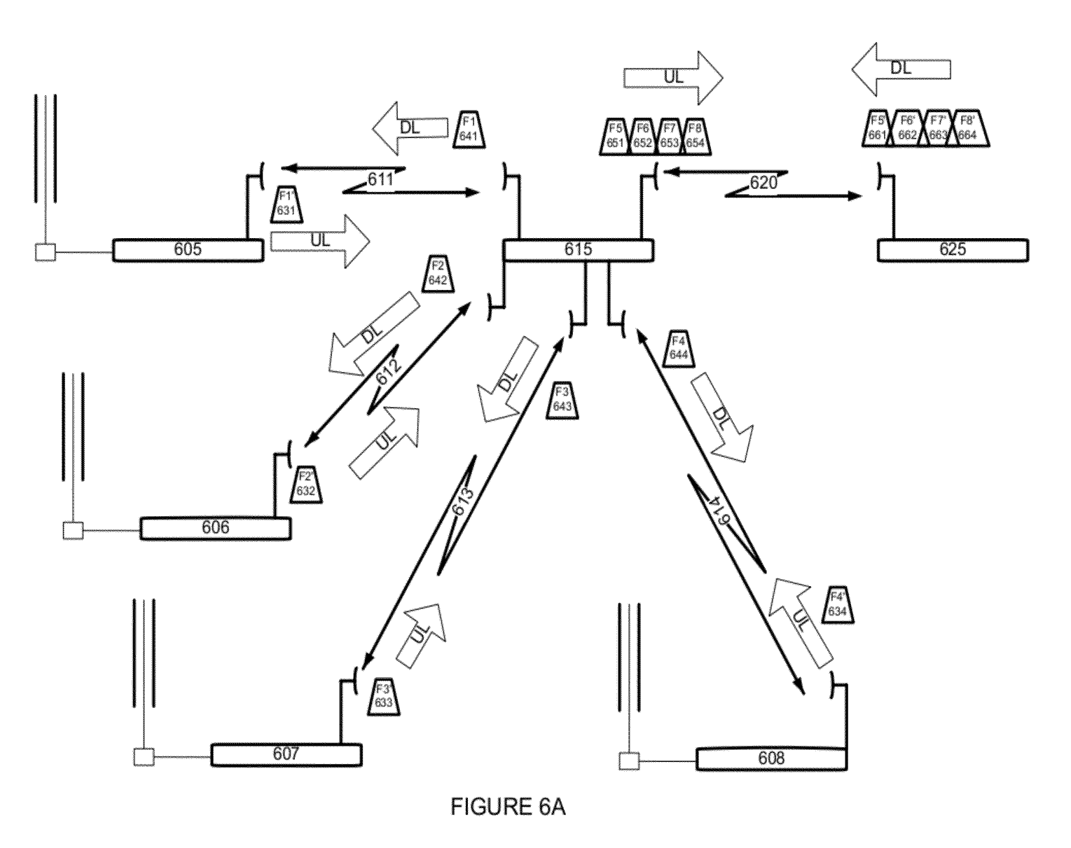

Reference is now made to FIGS. 5A and 5B, which are simplified block diagram illustrations of yet another example embodiment of the present invention.

FIG. 5A depicts an example scenario in which a first communication node 505 communicates via a wireless point-to-point link 510 to a second communication node 515, and a third communication node 506 communicates via a wireless point-to-point link 511 to the second communication node 515. The second communication node 515 acts as an aggregation node, collecting the traffic uplinked from the first communication node 505 and the third communication node 506, and uplinking the aggregated traffic via a wireless point-to-point link 520 to a fourth communication node 525. The second communication node 515 also acts as a node for downlinking, receiving traffic downlinked from the fourth communication node 525, and transmitting to each of the first communication node 505 and the third communication node 506, downlink traffic which is intended for that communication node.

The scenario of FIG. 5A depicts, for example, two channels of 14 MHz, F1 531 and F2 532 in an uplink direction from the first communication node 505 to the second communication node 515, and two channels of 14 MHz, F3 533 and F4 534 in an uplink direction, from the third communication node 506 to the second communication node 515. Corresponding downlink channels are also depicted, two channels F1′ 536 and F2′ 537 between the second communication node 515 and the first communication node 505, and two channels F3′ 538 and F4′ 539 between the second communication node 515 and the third communication node 506.

The second communication node 515, termed the aggregation node, has four uplink channels F5′ 541, F6′ 542, F7′ 543, and F8′ 544 for transmitting to the fourth communication node 525, and four downlink channels F5 546, F6 547, F7 548, and F8 549 for receiving from the fourth communication node 525.

FIG. 5A depicts traditional, prior art, symmetric allocation of the channel capacity. Using example quantitative values, FIG. 5A depicts an aggregation of two 14 MHz tails and one 28 MHz feed. Overall 2×28 MHz=56 MHz is used, providing about 200 Mbps at the feed and 100 Mbps for each tail.

FIG. 5B depicts an example embodiment of the invention applied to the communication nodes of FIG. 5A, and the frequency band allocation of FIG. 5A.

FIG. 5B depicts an asymmetric capacity allocation, taking into account, the example about threefold larger capacity used in downlink links over uplink links.

FIG. 5B depicts one channel of 14 MHz, F1 551 in an uplink direction from the first communication node 505 to the second communication node 515, and one channel of 14 MHz, F2 552 in an uplink direction, from the third communication node 506 to the second communication node 515.

Corresponding downlink channels are also depicted, three channels F1′ 553, F2′ 554, and F3′ 555, between the second communication node 515 and the first communication node 505, and three channels F4′ 556, F5′ 557, and F6′ 558, between the second communication node 515 and the third communication node 506.

The second communication node 515, termed the aggregation node, has two uplink channels F7′ 561, and F8′ 562, for transmitting to the fourth communication node 525, and six downlink channels F3 563, F4 564, F5 565, F6 566, F7 567, and F8 568 for receiving from the fourth communication node 525.

FIG. 5B depicts how a capacity of about 300 Mbps is achieved at the feed using a 42 MHz channel for downlink, and 14 MHz for uplink, and a capacity of about 150 Mbps is achieved at the tails using a 21 MHz channel for downlink and 7 MHz for uplink.

FIG. 5B uses the allocated 56 MHz spectrum to achieve 50% more capacity than FIG. 5A.

It is noted that if the channels F1-F8 and F1′-F8′ happen to be contiguous channels, the arrangement of FIG. 5B places the channels such that the each one of the transmitters at the four nodes 505 506 515 525 can each transmit contiguous channels, which makes for a simpler and more efficient transmission.

Contiguous channels are not a requirement for embodiments of the present invention, but a contiguous channel arrangement provides potential advantages such as a saving in hardware, using less hardware when the channels are contiguous; and some extra capacity in using one contiguous band rather than the same total bandwidth split into several non-contiguous sub-bands.

A Second Aggregation Scenario

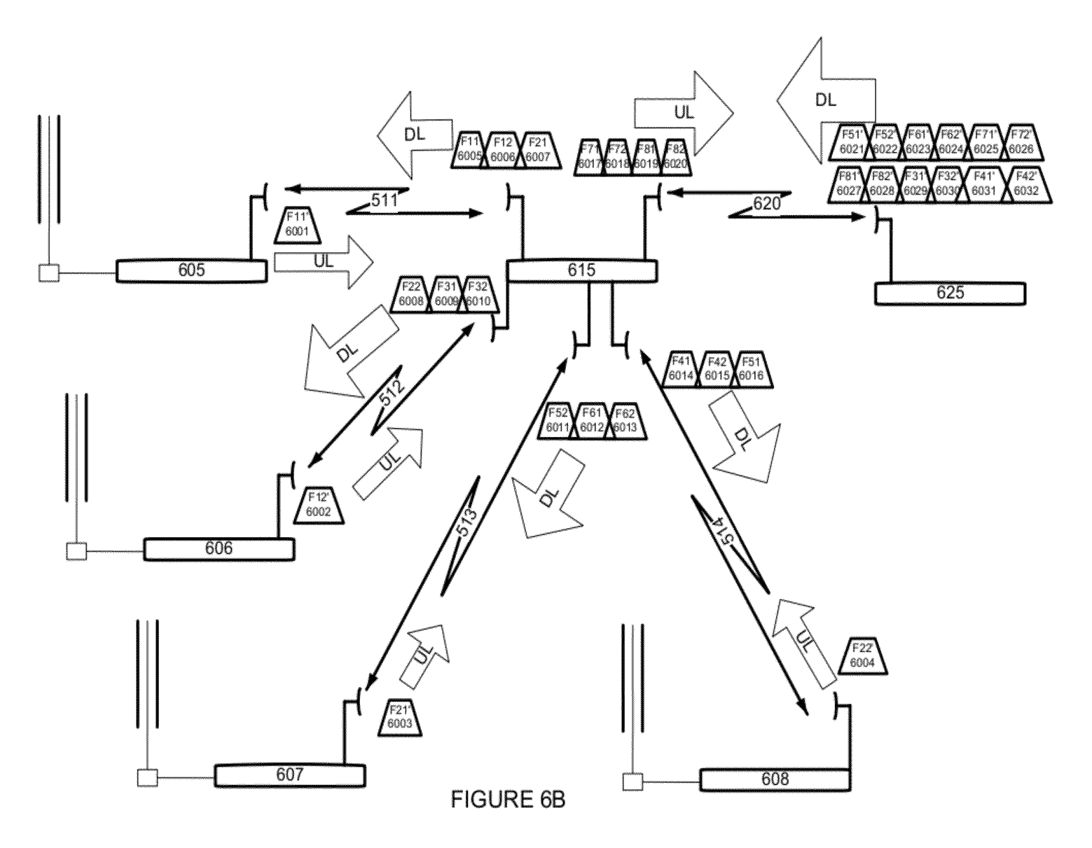

Reference is now made to FIGS. 6A and 6B, which are simplified block diagram illustrations of still another example embodiment of the present invention.

FIG. 6A depicts an example scenario in which four communication nodes 605 606 607 608 communicate via wireless point-to-point links 611 612 613 614 to an aggregator communication node 615. The aggregator communication node 615 collects the traffic uplinked from the four communication nodes 605 606 607 608, and uplinks the aggregated traffic via a wireless point-to-point link 620 to a sixth communication node 625. The aggregator communication node 615 also acts as an aggregation station for downlinking, receiving traffic downlinked from the sixth communication node 625, and transmitting to each of the four communication nodes 605 606 607 608 downlink traffic which is intended for that communication node.

FIG. 6A depicts, for example, one channel of 7 MHz tail (F1′ 631, F2′ 632, F3′ 633, and F4′ 634), from each one of the four communication nodes 605 606 607 608 uplinking into the aggregator communication node 615.

FIG. 6A also depicts 7 MHz channels (F1 641, F2 642, F3 643, and F4 644), downlinking one channel to each of the four communication nodes 605 606 607 608 from the aggregator communication node 615.

The aggregator communication node 615, has four uplink channels F5 651, F6 652, F7 653, and F8 654 of 7 MHz each, for transmitting to the sixth communication node 625, and four downlink channels F5′ 661, F6′ 662, FT 663, and F8′ 664 for receiving from the fourth communication node 525.

FIG. 6A depicts traditional, prior art, symmetric allocation of the channel capacity. Using example quantitative values, FIG. 5A depicts an aggregation of four 7 MHz tails and one 28 MHz feed. Overall 56 MHz are used, providing about 200 Mbps at the feed and 50 Mbps for each tail.

FIG. 6B depicts an example embodiment of the invention applied to the communication nodes of FIG. 6A, and the frequency band allocation of FIG. 6A.

FIG. 6B depicts an asymmetric capacity allocation, taking into account the example about threefold larger capacity used in downlink links over uplink links.

In FIG. 6B, each one of the 7 MHz channels is split into two sub-bands of 3.5 MHz, as follows: F1′ 631 (FIG. 6A) is split into F11′ 6001 and F12′ 6002, F2′ 632 (FIG. 6A) is split into F21′ 6003 and F22′ 6004, and correspondingly F3′ 633, F4′ 634, F5′ 661, F6′ 662, F7′ 663, F8′ 664, F1 641, F2 642, F3 643, F4 644, F5 651, F6 652, F7 653, and F8 654 are split into F31′ 6029, F32′ 6030, F41′ 6031, F42′ 6032, F51′ 6021, F52′ 6022, F61′ 6023, F62′ 6024, F71′ 6025, F72′ 6026, F81′ 6027, F82′ 6028, F11 6005, F12 6006, F21 6007, F31 6009, F41 6014, F51 6016, F61 6012, F71 6017, and F81 6019.

FIG. 6B depicts, one channel of 3.5 MHz tail (F11′ 6001, F12′ 6002, F21′ 6003, and F22′ 6004), from each one of the four communication nodes 605 606 607 608 uplinking into the aggregator communication node 615.

FIG. 6B also depicts 3.5 MHz channels (F11 6005, F12 6006, F21 6007, F22 6008, F31 6009, F32 6010, F52 6011, F61 6012, F62 6013, F41 6014, F42 6015, and F51 6016), downlinking three channels to each of the four communication nodes 605 606 607 608 from the aggregator communication node 615.

The aggregator communication node 615, has four 3.5 MHz uplink channels F71 6017, F72 6018, F81 6019, and F82 6020, for transmitting to the sixth communication node 625, and twelve downlink channels F51′ 6021, F52′ 6022, F61′ 6023, F62′ 6024, F71′ 6025, F72′ 6026, F81′ 6027, F82′ 6028, F31′ 6029, F32′ 6030, F41′ 6031, F42′ 6032 for receiving from the fourth communication node 525.

FIG. 6B depicts how a capacity of about 300 Mbps is achieved at the feed using a 42 MHz channel for downlink, and 14 MHz for uplink. A capacity of about 75 Mbps is achieved at the tails using a 10.5 MHz channel for downlink and 3.5 MHz for uplink.

FIG. 6B uses the allocated 56 MHz spectrum to achieve 50% more capacity than FIG. 6A.

A Ring Network Scenario

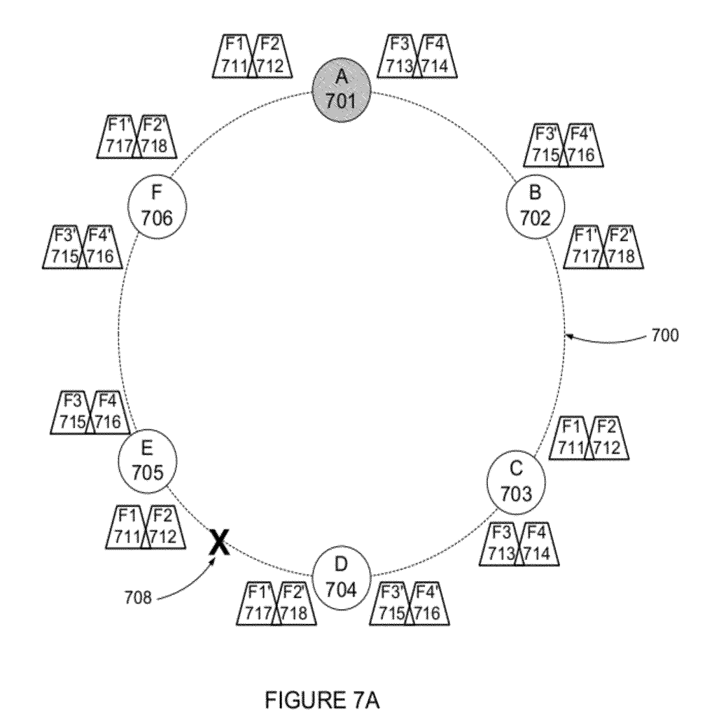

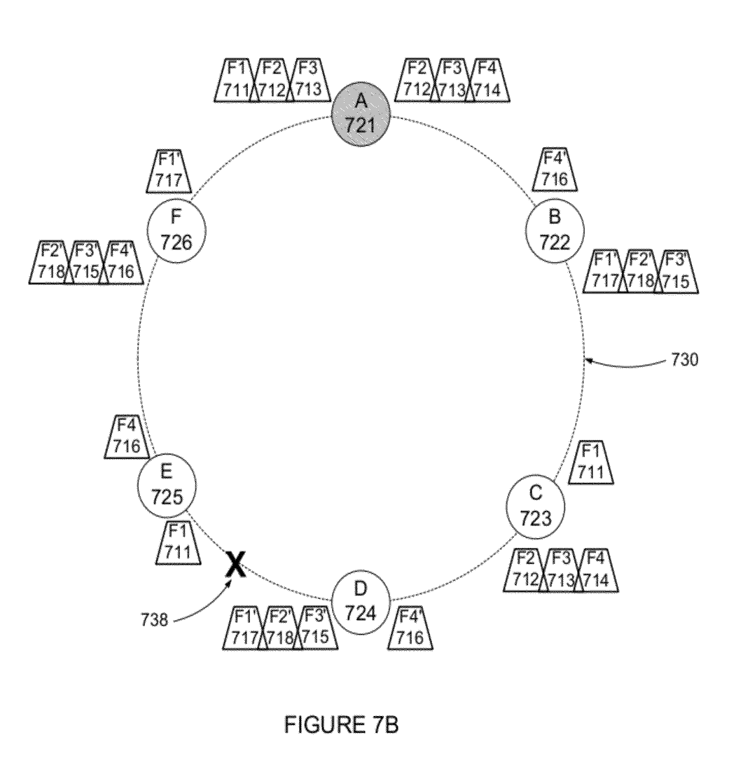

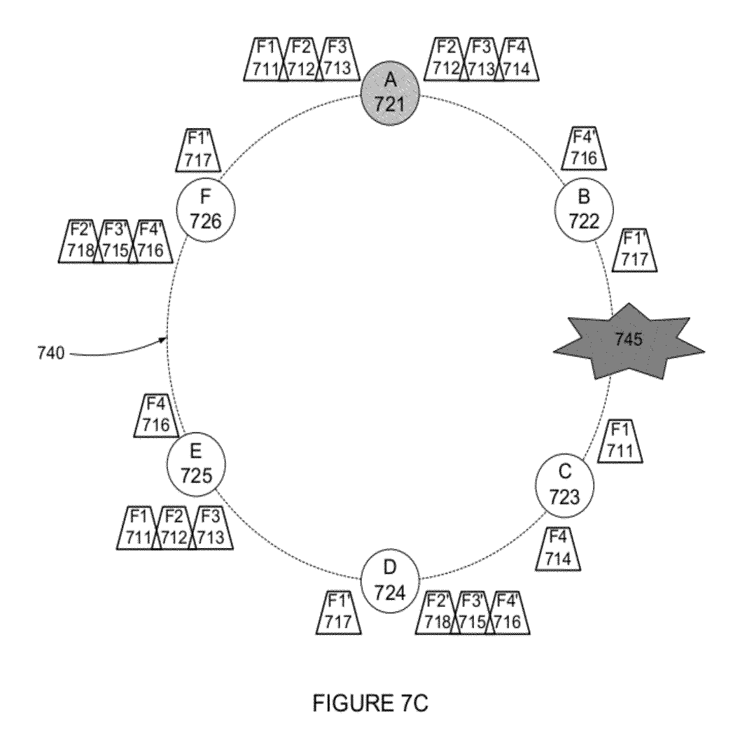

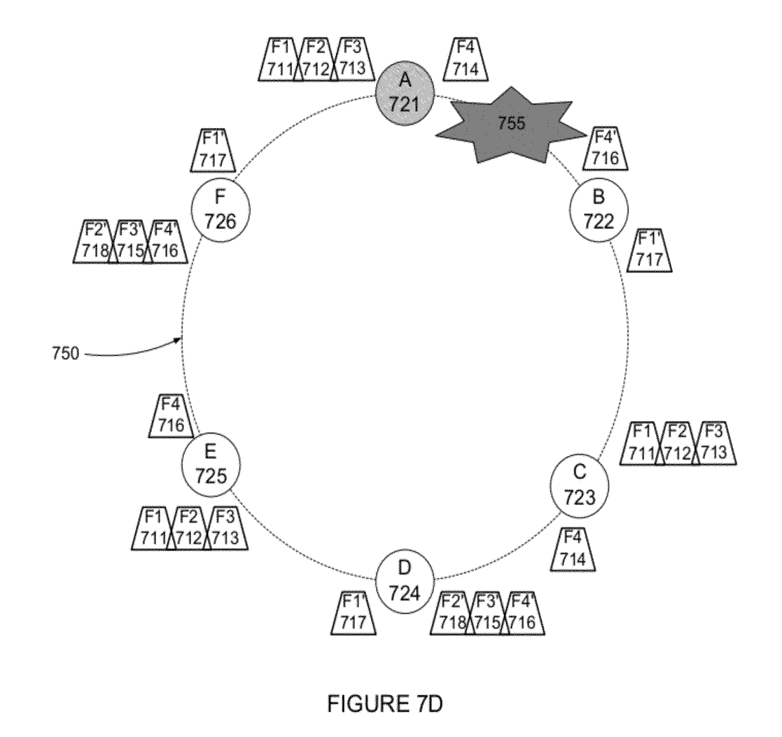

Reference is now made to FIG. 7A, which is a simplified block diagram illustration of communication nodes in a ring network.

FIG. 7A depicts an example scenario in which six wireless communication nodes A 701, B 702, C 703, D 704, E 705, and F 706, are arranged in a ring network 700.

The ring network 700, according to a traditional, prior art, bandwidth allocation, uses two 28 MHz channels to communicate to each side of the communication nodes A 701, B 702, C 703, D 704, E 705, and F 706.

As typically done in packet networks, the ring network 700 topology may be cut by using a Spanning-Tree Protocol (STP). A cut position 708 is marked by an X in FIG. 7A.

The communication node A 701 in FIG. 7A denotes a main entry point to the ring. Traffic coming out of this node in the direction of the cut position 708 of the ring network 700 is termed downlink traffic. Traffic from other nodes toward node A 701 is termed uplink traffic.

FIG. 7A depicts making use of eight different frequency bands of 14 MHz: F1 711, F2 712, F3 713, F4 714, F1′ 717, F2′ 718, F3′ 715, and F4′ 716, with a re-use of some of the allocated frequencies, as depicted in the drawing.

The network rings supports a capacity of 200 Mbps (100 Mbps in each direction), provided by 2×14 MHz=28 MHz in each direction.

The network ring divides up the total capacity of 200 Mbps between the network nodes, so the network ring sustains up to 66 Mbps per communication node, when the longer path is taken from node A 701 to node D 704, and the 200 Mbps is divided between the nodes B 702, C 703, and D 704. The network ring can drop to 40 Mbps per communication node if there is a failure near a root communication node, for example next to node A 721.

Reference is now made to FIG. 7B, which is a simplified block diagram illustrations of yet another example embodiment of the present invention, applied to a ring network 730 similar in topology to the ring network of FIG. 7A.

FIG. 7B depicts an example embodiment of the invention applied to a ring network 730 having a ring network topology similar to that of FIG. 7A, and the frequency band allocation of FIG. 7A.

FIG. 7B depicts an asymmetric capacity allocation, taking into account the example about threefold larger capacity used in one direction along a wireless link than an opposite direction.

As typically done in packet networks, the ring network 730 topology may be cut by using a Spanning-Tree Protocol (STP). A cut position 738 is marked by an X in FIG. 7B.

The communication node A 721 in FIG. 7B denotes a main entry point to the ring. Traffic coming out of this node in the direction of the cut position 738 of the ring network 730 is termed downlink traffic. Traffic from other nodes toward node A 721 is termed uplink traffic.

The ring network of FIG. 7B supports a capacity of 300 Mbps from a root node A 721 in both directions, and 100 Mbps toward the root node A 721, as long as there are no failures in the ring.

The ring network of FIG. 7B supports 50% more capacity than the ring network of FIG. 7A.

Reference is now made to FIG. 7C, which is a simplified block diagram illustration of a network 740 similar to the ring network of FIG. 7B, when a failure occurs in a wireless link far from a root node.

In case of a failure of a wireless link, for example at a location 745 between nodes B 722 and C 723, frequency segment allocation is changed at communication nodes C 723, D 724, and E 725, so as to maintain a downlink, or higher capacity direction from the root node A 712, and an uplink, or lower capacity, in an opposite direction.

The network of FIG. 7C still provides 300 Mbps in a downlink direction, and 100 Mbps in an uplink direction.

Reference is now made to FIG. 7D, which is a simplified block diagram illustration of a network 750 similar to the ring network of FIG. 7B, when a failure occurs in a wireless link close to a root node.

In case of a failure of a wireless link, for example at a location 755 between nodes A 721 and B 722, frequency segment allocation is changed at communication nodes B 722, C 723, D 724, and E 725, so as to maintain a downlink, or higher capacity, direction from the root node A 712, and an uplink, or lower capacity in an opposite direction.

The network of FIG. 7D still provides 300 Mbps in a downlink direction, which translates to 60 Mbps per site in the downlink direction, which is 50% more than the network of FIG. 7A can provide.

Ring Networks in Summary

Asymmetric allocation of capacity in the wireless links can increase utilization of a ring.

In some embodiments of the invention, the communication nodes are constructed so as to be able to provide, for example, three sub-bands of communication in either direction (as in FIGS. 7B, 7C, and 7D) rather than two sub-bands in either direction (as in FIG. 7A). When a failure is detected in a network ring, a command is sent to specific nodes, for example to operate a setup script, and switch use from three sub-bands to a first direction of the communication node and one sub-band to a second direction of the communication node, to use one sub-band to the first direction of the communication node and three sub-bands to the second direction of the communication node.

An example such script mechanism operates as follows:

For a Root port (a port in a direction of a root node of a ring)—assign one frequency segment.

For a Designated port—assign three segments.

For a Blocked port, which is a port to a cut position,—assign one segment.

For a Failed port, which is a port to a failed link,—assign one segment. It is noted that in some embodiments of the invention a link may be considered failed when the link downgrades below a specific quality threshold, while in other embodiments of the invention a link may be considered failed when the link cannot support any communication at all.

It is noted that the above example script works based on a 3:1 ratio, other ratios may be implemented as described above with reference to FIG. 3. It is also noted that where one segment is allocated, and three segments are allocated, other numbers of segments may be replaced, while still maintaining a desired ratio.

Shared Capacity

Using a script to configure different capacities at each side of a link, it is possible to buy one channel and use the one channel to backhaul several sites.

In some embodiments of the invention, an aggregator node transmits one signal to two or more tail nodes, where the signal contains data for all the tail nodes. The tail nodes transmit their own data to the aggregator node. By the aggregator node sharing transmission capacity to all the tail nodes, that is, transmitting one common signal to all the tail nodes, the aggregator node may dynamically be sending more data to one tail node than to another, while at the same time not exceeding a total bandwidth allocated for transmitting downstream, to the tail nodes. Due to a statistical nature of transmitting data from an aggregator node to different tail nodes, the aggregator node may effectively provide more bandwidth to each node, sometimes, than would be possible if each node were to get allocated a fixed bandwidth for downstream communications.

By way of a non-limiting example, we shall now show how one channel may be configured to backhaul four sites.

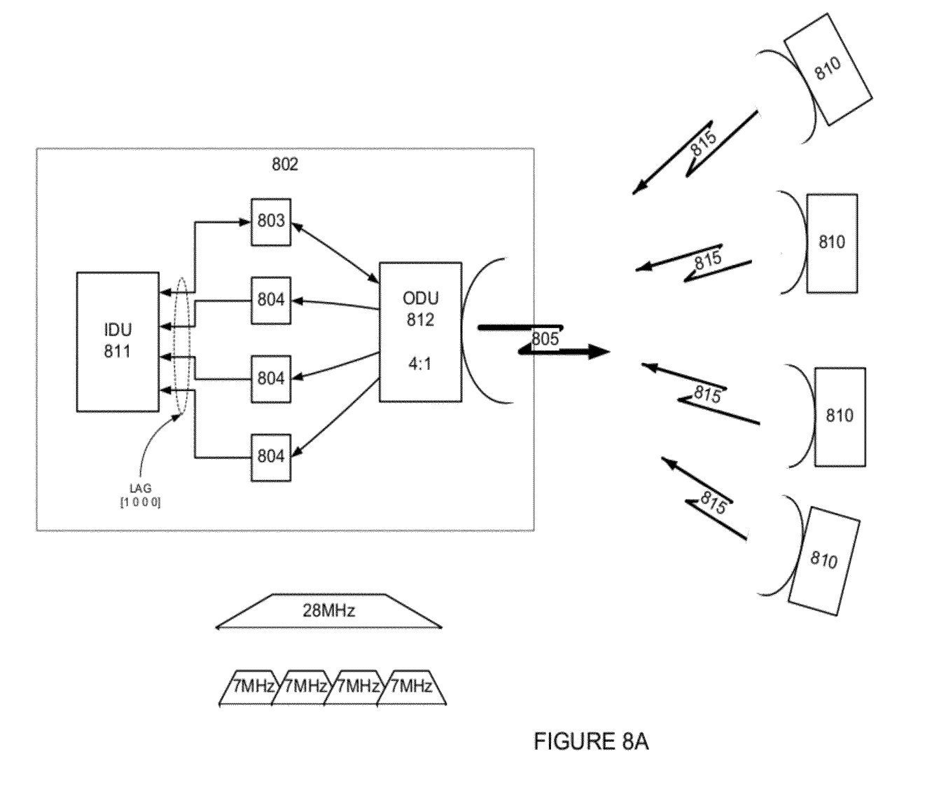

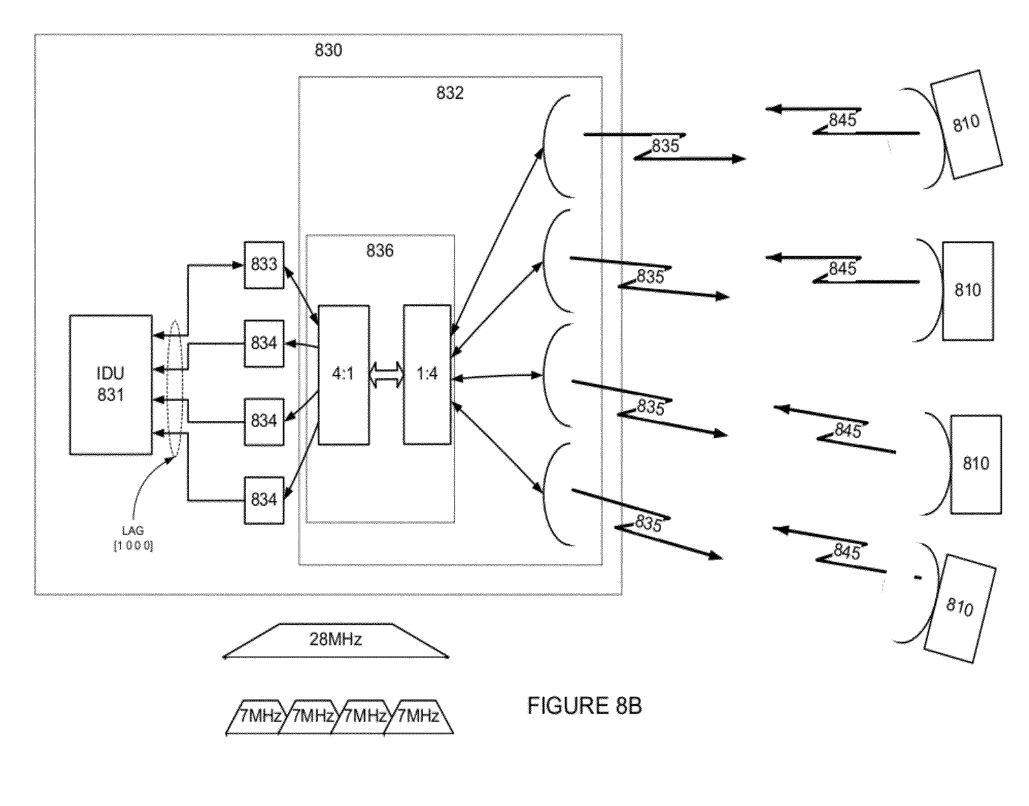

Reference is now made to FIG. 8A, which is a simplified block diagram of an example embodiment of the invention used for sharing capacity of a wireless point-to-point link.

FIG. 8A depicts a first communication node 802 transmitting to four wireless communication nodes 810. The first communication node 802 optionally transmits to a relatively broad angle, which includes the four wireless communication nodes 810. By way of a non-limiting example, the first communication node 802 uses one 28 MHz channel to transmit a downlink channel 805 to the four wireless communication nodes 810. The one 28 MHz channel contains data meant for all four of the wireless communication nodes 810. Each of the four wireless communication nodes 810 picks out its own data.

In some embodiments of the invention, the tail nodes 810 are end nodes, so the tail nodes 810 pick out their own data according to their MAC addresses.

In some embodiments of the invention, the tail nodes 810 pass data on to additional nodes in a network. In some embodiments of the invention, the tail nodes 810 pass the data through a router, which drops data not belonging to MAC addresses routing through the router. In some embodiments of the invention, the tail nodes 810 pass all the data which is received on to the additional nodes in the network.

The first communication node 802 receives 4 uplink communication channels 815, each having a bandwidth of one quarter of the 28 MHz channel, that is 7 MHz each, from each of the four sites, at four different sub-band frequencies. A channel of 28 MHz which is traditionally used in the uplink direction is divided to four sub-bands of 7 MHz each.

The following is achieved:

At the uplink, from tail node 810 to aggregation node 802, each tail node 810 has a capacity of 7 MHz, for a capacity of up to about 42 Mbps per tail.

At the downlink we have a shared bandwidth of 28 MHz, for a capacity of about 180 Mbps for all the 4 tail nodes 810. It is noted that a bandwidth of 28 MHz provides a capacity of about 180 Mbps, which is more than 4 times the capacity of four bands of 7 MHz which each provide a capacity of about 42 Mbps. The shared bandwidth allows flexibility—more data may be sent to one of the communication nodes 810 than one quarter of the 180 Mbps, when the other three communication nodes 810 require less than three quarters of the 180 Mbps available.

The downlink provides an average of 45 Mbps for each tail node 810, but bursts as high as 180 Mbps per site may be sent if other tail nodes are not requiring capacity at that time, or a somewhat lower peak capacity may be used if other nodes require a low capacity. Since data bursts do not typically happen at all tail nodes at once, it is possible to increase peak downlink capacity to a single tail node by up to fourfold.

In an example embodiment of the invention the first communication node 802 includes an Indoor Unit (IDU) 811, connected to a first modem 803 configured with 28 MHz for Tx and 7 MHz for Rx, and also connected to three modems 804 configured with 7 MHz for Rx, and an Outdoor Unit (ODU) 812 connected to the four modems 803 804.

An Indoor Unit 811 produces a Tx signal fed into the first modem 803.

Only the first modem 803 transmits data to the downlink channel 805. The other three modems 804 do not use a Tx channel, for example by muting at an Outdoor Unit and/or at an entrance to an antenna connected to the other three modems 804.

Output of the Tx channel of the first modem 803 is provided to a wide angle antenna, capable of transmitting to the four tail nodes 810.

The IDU 811, when receiving the uplink transmissions, optionally treats the 4 links from the modems 803 804 as one Link Aggregation (LAG) of 4 links The LAG is used with a distribution function of [1 0 0 0]. In LAG several Ethernet ports are optionally treated as one logical port. In prior art LAG frames are distributed among the ports. In an example embodiment of the invention the frames are forced to use one Ethernet port, in the transmit direction. In the receive direction LAG, according to the example embodiment of the invention, accepts frames from all its ports.

The first communication node 802, which acts as an aggregator node, learns MAC addresses of the tail nodes 810, and treats the MAC addresses as if they arrive from the same port.

In some embodiments of the invention, Automatic Transmit Power Control (ATPC) is optionally enabled from the tail nodes 810 to the aggregator node 802, on the 7 MHz channels, to possibly decrease interference between adjacent signals.

In some embodiments of the invention, especially in cases where a single antenna does not transmit in a broad enough angle to be received with good quality by the tail nodes 810, several antennas are used, optionally one antenna for each tail node.

Reference is now made to FIG. 8B, which is a simplified block diagram of another example embodiment of the invention used for sharing capacity of a wireless point-to-point link.

FIG. 8B depicts a first communication node 830 transmitting to four wireless communication nodes 810. The first communication node 830 optionally transmits via four antennas to the four wireless communication nodes 810.

By way of a non-limiting example, the first communication node 830 uses a 28 MHz channel to transmit a downlink channel 835 to the four wireless communication nodes 810, via four antennas, containing the same data.

The first communication node 830 receives 4 uplink communication signals 845, each having bandwidth of one quarter of the 28 MHz channel, that is 7 MHz each, from each of the four tail nodes 810, at four different sub-band frequencies. A channel of 28 MHz which is traditionally used in the uplink direction is divided to four sub-bands of 7 MHz each.

The following is achieved:

At the uplink, from the tail nodes 810 to an aggregation node 830, each tail node 810 has a capacity of 7 MHz, for a capacity of up to about 42 MBps per tail.

At the downlink we have a shared bandwidth of 28 MHz, for a capacity of 180 Mbps for all the 4 tail nodes 810.

The downlink provides an average of 45 Mbps of data for each tail node 810, but bursts as high as 180 Mbps per site may be sent, if other tail nodes are not requiring capacity at that time, or a somewhat lower peak capacity may be used if other nodes require a low capacity. Since data bursts don't typically happen at all tail nodes at once, it is possible to increase peak downlink capacity to a single tail node by up to fourfold.

In an example embodiment of the invention the first communication node 830 includes an Indoor Unit (IDU) 831, connected to a first modem 833 configured with 28 MHz for Tx and 7 MHz for Rx, and also connected to three modems 834 configured with 7 MHz for Rx, and an Outdoor Unit (ODU) 832 connected to the four modems 833 834.

The Indoor Unit 831 produces a Tx signal fed into the first modem 833.

Only the first modem 833 transmits data to the downlink channels 835. The other three modems 834 don't use a Tx channel, for example by muting at their output. A 4:1:4 multiplexer-demultiplexer 836 connects output of the modems 833 834 to antennas, such that the Tx signal is transmitted from the first modem 833 to all four antennas, and each one of the four Rx signals 845 received by the four antennas is fed into one of the four modems 833 834.

The IDU 831, when receiving the uplink transmissions, optionally treats the 4 links from the modems 833 834 as one Link Aggregation (LAG) of 4 links. The LAG is used with a distribution function of [1 0 0 0].

The first communication node 830, which acts as an aggregator node, learns MAC addresses of the tail nodes 810, and treats the MAC addresses as if they arrive from the same port.

In some embodiments of the invention, Automatic Transmit Power Control (ATPC) is optionally enabled from the tail nodes 810 to the aggregator node 830, on the 7 MHz channels, to possibly decrease interference between adjacent signals.

In some embodiments of the invention, especially in cases where a single antenna does not transmit in a broad enough angle to be received with good quality by the tail nodes 810, several antennas are used, optionally one antenna for each tail node.

It is expected that during the life of a patent maturing from this application many relevant wireless transmission codings and modulations will be developed and the scope of the terms wireless communication and wireless transmission are intended to include all such new technologies a priori.

The terms “comprising”, “including”, “having” and their conjugates mean “including but not limited to”.

The term “consisting of” is intended to mean “including and limited to”.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein the term “about” refers to ±10%.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of allocating wireless communication capacity in a wireless point-to-point link comprising:
obtaining a channel having a bandwidth for use in the wireless point-to-point link;
allocating a first portion of the bandwidth for use for transmitting from a first point to a second point of the wireless point-to-point link; and
allocating a second portion of the bandwidth for use for transmitting from the second point to the first point of the wireless point-to-point link,
in which the bandwidth is asymmetrically assigned between the first portion and the second portion.

2. The method of claim 1 in which the bandwidth is split into a plurality of substantially equal sub-bands, and in which the sub-bands are allocated to the first portion and to the second portion according to channel usage characteristics.

3. The method of claim 2 in which a number of sub-bands allocated to the first portion is different from a number of sub-bands allocated to the second portion.

4. The method of claim 3 in which the number of sub-bands allocated to the first portion is in a ratio of 3:1 to the number of sub-bands allocated to the second portion.

5. The method of claim 1 in which the wireless link comprises a wireless link between an aggregation node and a tail node.

6. The method of claim 1 in which the wireless link comprises a wireless link between communication nodes in a wireless network having a ring topology.

7. A method of allocating bandwidth in a wireless communication system between an aggregator node and a plurality of tail nodes, comprising:
obtaining a channel having a bandwidth for use between the aggregator node and the plurality of tail nodes;
allocating a first portion of the bandwidth for use for transmitting from the aggregator node to the plurality of tail nodes; and
allocating a plurality of other portions of the bandwidth for use for transmitting from the tail nodes to the aggregation node;
characterized by using the first portion to transmit a same signal to all the tail nodes.

8. The method according to claim 7, in which the bandwidth of the first portion is substantially equal to a sum of the bandwidth of the other portions.

9. The method according to claim 7, in which the same signal sometimes contains data using up more bandwidth to one of the tail nodes than can be contained in the portion of bandwidth allocated to the same one of the tail nodes for transmitting from the same one of the tail nodes to the aggregation node.
